(19) United States
(12) Patent Application Publication
(10) Pub. No.: US 2020/0217675 A1
(43) Pub. Date: Jul. 9, 2020

(54) DETERMINING ROUTE TO DESTINATION

(71) Applicant: International Business Machines Corporation, Armonk, NY (US)

(72) Inventors: Ramratan Vennam, Durham, NC (US); Belinda Marie Vennam, Durham, NC (US); Spencer Thomas Reynolds, Austin, TX (US); Saikrishna Vennam, Foster City, CA (US)

(21) Appl. No.: 16/239,969

(22) Filed: Jan. 4, 2019

(51) Int. Cl. G01C 21/34; G08G 1/015

(52) U.S. Cl. CPC G01C 21/3453; G08G 1/015

(57) ABSTRACT

Example techniques are described for determining a driving route based on factors such as amounts and relative concentrations of different types of vehicles. The amounts and relative concentrations of different types of vehicles includes concentration of degrees of autonomy for the different types of vehicles such as amount and concentrations of autonomous and semi-autonomous vehicles.

### BACKGROUND

Navigation systems, including standalone GPS devices, mobile-device-based applications, or other mapping software, are used to determine an ideal route to a destination. The default route is often based on the shortest estimated time to the destination. These suggested routes will factor in, for example, the speed limits of roads, density of traffic, and current known accidents. In certain systems, users may be presented with multiple routes from which to choose, based on other preferred route aspects and user criteria. For example, Google Maps™ allows users to toggle route options based on avoiding tolls, ferries, and/or highways.

### SUMMARY

In one example, the disclosure describes a system including a receiver configured to receive, based on a first driving route, first route data indicative of amounts and relative concentrations of different types of vehicles associated with the first driving route, and processing circuitry configured to determine, based at least in part on the first route data and safety data indicating safety of the different types of vehicles, a first relative safety rating for the first driving route, determine, based at least in part on the first relative safety rating, a recommended driving route; and output information indicating the recommended driving route.

In one example, the disclosure describes a method comprising receiving, based on a first driving route, first route data indicative of amounts and relative concentrations of different types of vehicles associated with the first driving route, determining, based at least in part on the first route data and safety data indicating safety of the different types of vehicles, a first relative safety rating for the first driving route, determining, based at least in part on the first relative safety rating, a recommended driving route, and outputting information indicating the recommended driving route.

In one example, the disclosure describes a computer-readable storage medium storing instructions thereon that when executed cause one or more processors to receive, based on a first driving route, first route data indicative of amounts and relative concentrations of different types of vehicles associated with the first driving route, determine, based at least in part on the first route data and safety data indicating safety of the different types of vehicles, a first relative safety rating for the first driving route, determine, based at least in part on the first relative safety rating, a recommended driving route, and output information indicating the recommended driving route.

The details of one or more aspects of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram depicting a vehicle navigation system, in accordance with some examples of this disclosure.

FIG. 2 is another block diagram depicting a vehicle navigation system, in accordance with some examples of this disclosure.

FIG. 3 is a flow diagram depicting a method of determining a route to a destination, in accordance with some examples of this disclosure.

### DETAILED DESCRIPTION

In general, this disclosure describes systems and methods for determining and selecting a safest estimated route to a destination. One example of such a system includes a device configured to receive data indicating the number and concentration of autonomous and semi-autonomous vehicles currently on a potential driving route. “Autonomous” and “semi-autonomous” are terms to refer to degrees of autonomy for the different types of vehicles. The device may then use this data as one of multiple factors to determine an estimated relative safety rating for that route.

Recent advances in accident-avoidance technology have resulted in a new fleet of vehicles manufactured with sets of semi-autonomous, and increasingly, fully autonomous safety features. Some examples of these features include hazard detection and automatic braking. These advanced safety technologies impart a set of positive externalities on the roadways—i.e., they provide safety benefits not only for the occupants of the vehicles in which they are installed, but also to the vehicles around them. It may be inferred that a driving route with a higher concentration of autonomous and semi-autonomous vehicles is likely to be safer than a route with a lower such concentration.

Current commercial navigation systems, for example, mobile applications such as Google Maps™ or Waze™, allow the user to select from a number of driving routes to one destination, based on different sets of desired criteria. For example, a user may select the shortest-distance route, the fastest route, or the cheapest route (i.e., no tollways). However, there is not currently a navigation system that allows a user to select an estimated safest route based on any number of accident-reducing criteria. Hence, the example techniques may provide for example navigation systems that are a technical improvement over other types of navigation system, and for practical applications for such navigation systems.

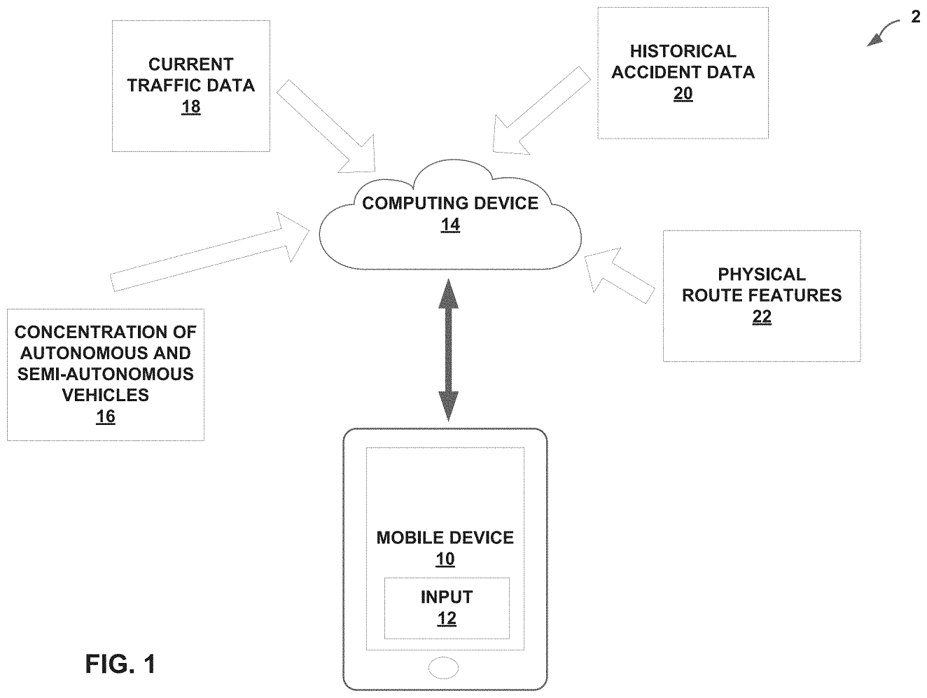

FIG. 1 is a block diagram depicting a vehicle navigation system 2 in accordance with some examples of this disclosure. In some examples, a navigation system may include a mobile device configured with navigation software, such as a mobile application on smartphone 10. In other examples, a navigation system may include a standalone GPS navigation device configured with software. In other examples, a navigation system may include a dashboard control system of a vehicle, configured with factory-installed software.

In some examples, a navigation system may include means for user input 12, through which a user may indicate an intended destination. In some examples, user input 12 may include a virtual keyboard appearing on a touchscreen. In other examples, user input 12 may include a physical keyboard, such as with a personal computing device. User input 12 may also include a microphone, wherein the navigation system may incorporate speech-recognition software to translate audio data into a searchable destination. In some examples, a user may select an intended destination on an image displayed on a touch screen featuring a map.

Once user input 12 has received information indicating an intended destination, navigation system 2 may relay this information to a computing device 14, for example, a cloud-based server including processing circuitry and memory storing a database of map locations to determine whether the system recognizes the input as indicating a single, distinct location. In some examples, computing device 14 may determine the user input to be ambiguous, returning multiple recognized locations as output. In this example, computing device 14 may determine and assign a probability value for each of the alternative locations. In the event that one of the locations is significantly more probable to have been intended by the user, computing device 14 may output that location to the navigation device 10. Alternatively, if the system recognizes two or more equally likely locations, computing device 14 may output each of these locations to device 10 and prompt the user to select from among them.

Once the user has confirmed a single, recognized location as the intended destination, computing device 14 may determine one or more candidate routes from the user's current location to the intended destination. In some examples, the determination of candidate driving routes may occur directly on processing circuitry within the local device 10, or via a cloud-based computing device 14 and then relayed back to device 10, or performed by a separate intermediary navigation service.

In some examples in accordance with this disclosure, computing device 14 within vehicle navigation system 2 may be configured to retrieve one or more sets of data associated with the relative safety of each candidate route to a user's intended destination. In some examples, computing device 14 may be located in a cloud-based data-processing and storage server, or alternatively, located within a device 10 that is local to the user, such as within a mobile device, GPS navigation device, personal computing device, or vehicle dashboard.

In some examples, device 10 may display to a user the option to rank or weight various criteria on which computing device 14 may base its determination of a safest recommended driving route. Alternatively, computing device 14 may default to a predetermined algorithm for ranking various factors associated with a particular driving route's relative safety.

In some examples, computing device 14 may retrieve information 16 indicative of the relative concentration of autonomous and semi-autonomous vehicles—i.e., vehicles factory-installed with technologically advanced safety features, including collision-and-accident-avoidance systems—associated with respective candidate driving routes. Autonomous and semi-autonomous are degrees of autonomy for the different types of vehicles.

For example, data 16 may include information indicative of the numbers of different types vehicles associated with a particular candidate driving route, including, for example, the concentration of vehicles currently on each segment of the route, the concentration of vehicles on the route over a predetermined recent time interval (e.g., the past five minutes), or a weighted average of all vehicles recorded to have ever driven on that route.

In some examples, computing device 14 may retrieve information 16 indicative of current traffic conditions along a candidate route. Routes with a lower amount of traffic (e.g., fewer vehicles and/or a more consistent flow of vehicles) may be determined to be safer, in that there is a reduced probability of colliding with another vehicle.

In some examples, computing device 14 may retrieve information 20 indicating the total number of previous accidents recorded at each segment of that route. A route having fewer recorded past accidents may be determined to also be less likely to incur fewer accidents in the future.

In some examples, computing device 14 may also retrieve data indicative of individual physical features 22 of a candidate route. For example, a route with one or more sharp turns, blind intersections, animal or railroad crossings, road construction, or narrow shoulders may indicate a less safe route.

Computing device 14 may process route safety data from one or more sources to determine and assign a “relative safety rating” to each candidate driving route. Navigation system 2 may then determine the candidate route having the highest relative safety rating, and output information indicative of that route as a recommended safest route for display to the user, such as via a display on mobile device 10.

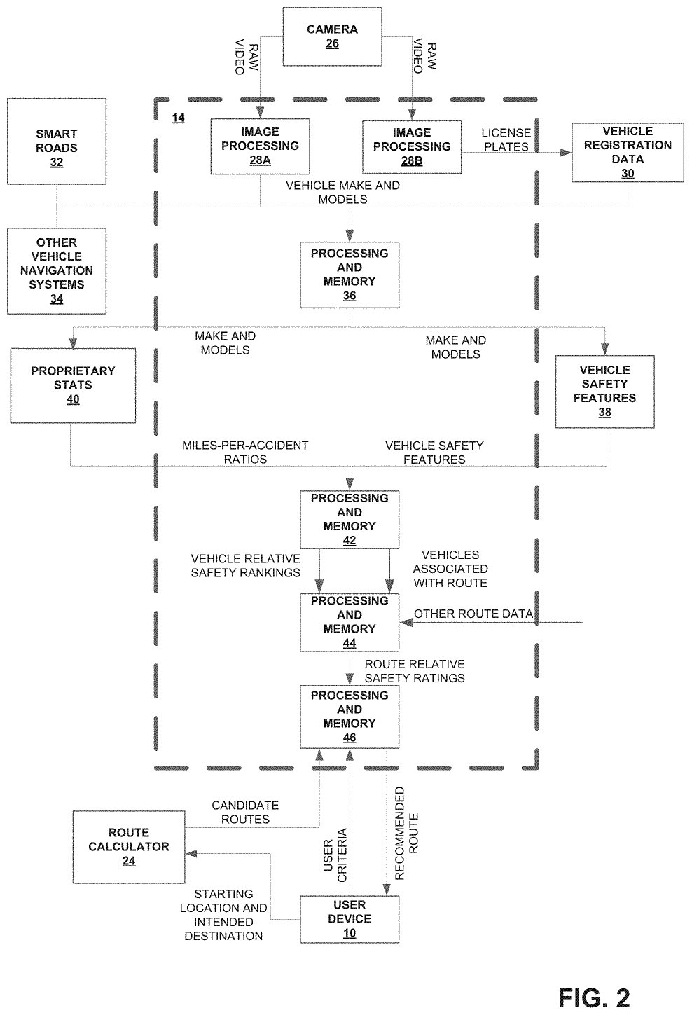

FIG. 2 is a block diagram depicting a vehicle navigation system 2, in accordance with some examples of this disclosure. Vehicle navigation system 2 may include computing device 14, having data processing circuitry and memory configured to execute instructions that cause computing device 14 to determine a safest recommended driving route to a destination, based at least in part on data indicative of the relative safety of vehicles along that route. In particular, navigation system 2 may include computing device 14 configured to determine a safest recommended route to a destination based at least in part on the amount and relative concentration of accident-avoidance safety features installed in vehicles associated with that route. In some examples, computing device 14 may include processing circuitry located in a cloud-based data-processing and storage center, or alternatively, located within a device 10 local to the user, such as a mobile device. It should be understood that, although FIG. 2 depicts computing device 14 including several processing and memory components 28A, 28B, 36, 42, 44, and 46, these individual components merely indicate distinct data processing routines to be performed by computing device 14 within navigation system 2, and any of these routines may in fact be performed by the same physical data-processing circuitry and/or memory storage devices. Processors 28A, 28B, 36, 42, 44, and 46 may be formed as at least one of fixed-function or programmable circuitry. Examples of the processing circuitry include microprocessors, application-specific integrated circuits (ASICs), field programmable gate arrays (FPGAs), digital signal processors (DSPs), or other equivalent integrated or discrete logic circuitry.

In some examples, a user may input information indicative of an intended destination and route criteria into device 10, such as a mobile device, GPS-device, personal computing device, or factory-installed vehicle navigation system. Device 10 may then transmit data indicative of the user's present location or a starting location, as determined by a GPS satellite or by user input, as well as the user's intended destination, to a route calculator 24.

Route calculator 24 may, for example, be included within local user device 10, cloud-based computing device 14, or a separate remote entity. Route calculator 24 may determine one or more reasonable routes from the user's present location or from a user-input starting location to an intended destination. Route calculator 24 may then transmit these candidate routes to computing device 14 within navigation system 2 to select a single recommended route based at least in part on data associated with the relative safety of each candidate route.

In some examples, computing device 14 may output to device 10 a prompt for a user to assign a weighted preference to, among other options of safety criteria factors, a driving route associated with the highest number and/or relative concentration of vehicles installed with advanced accident-avoidance technologies—i.e. semi-autonomous and fully autonomous vehicles. Computing device 14 may retrieve data indicative of semi-autonomous and fully autonomous vehicles associated with a candidate route from one or more sources.

In some examples, computing device 14 may communicate with one or more cameras 26. Camera 26 may include, for example, a traffic camera or surveillance camera installed at an intersection of two roads. In another example, camera 26 may include an exterior vehicle camera, installed within a vehicle as part of an accident-avoidance technology system.

In some examples, camera 26 may record and transmit data including its physical geolocation, a timestamp, and a series of raw images or video of its surrounding environment, which may include images of other vehicles in the vicinity. Computing device 14 may retrieve this data for each possible segment of each candidate route, as indicated by geolocation data from cameras 26. Processing circuitry 28A and/or 28B may analyze the raw image and video files to extract information indicative of the types of vehicles associated with the corresponding segment of the candidate route.

For example, processing circuitry 28A may be configured to execute image-processing software to analyze an image file and recognize one or more vehicles depicted in the image. Sufficiently advanced image-processing software may further be configured to recognize the manufacturer make, the vehicle model, and the year of manufacture, of each recognized vehicle, based at least in part on unique physical features of the shape of the vehicle. Processing circuitry 28A may then store data indicative of each recognized vehicle make and model, a timestamp, and its location, within a memory.

In another example, processing circuitry 28B may be configured to execute image-processing software to analyze an image file and recognize a license plate on a vehicle depicted in the image. The software may further include optical character recognition (OCR) to convert the license plate image to a text file. Processing circuitry 28B may then input the license plate information into a vehicle registration database 30, such as a state's Department of Motor Vehicles (DMV) in order to retrieve the registered make, model, and year of manufacture associated with that license plate. Processing circuitry 28B may then store data indicative of each vehicle make and model, the timestamp, and the location, within a memory.

In some examples, computing device 14 may retrieve information indicative of the types of vehicles associated with a segment of a candidate route from additional or alternate sources. For example, some technologically advanced vehicles may be in communication with “smart” roads 32, which may implement a traffic management system to route and manage vehicles efficiently. If a candidate routes includes smart road 32, computing device 14 may retrieve data stored by smart road 32 indicating any vehicles it has communicated with.

In another example, a second user may also have implemented an instance of vehicle navigation system 2, in the form of navigation system 34. Navigation system 34 may have prompted the second user to input the second user's vehicle make and model information or may have retrieved it automatically from the second vehicle, such that navigation systems 2 and 34 may mutually exchange vehicle make and model information.

Once computing device 14 has retrieved and processed vehicle make-and-model, time, and location information for a plurality of segments of candidate routes, computing device 14 may further process the data for efficient storage. For example, processing circuitry and memory 36 may determine and store a histogram indicating the frequency of each type of vehicle for a given segment of road for a pre-determined amount of time. A pre-determined amount of time may indicate, for example, a continuously refreshing “current” set of vehicles on the road—i.e., a short amount of time (for example, five minutes), after which a new set of data is retrieved. In another example, processor 36 may update a database indicating the frequency of each type of vehicle that has ever been recognized at that particular segment of road, such that computing device 14 may determine a historical average of vehicle types in that location. Computing device 14 may output a prompt to device 10 for a user to indicate which set of information is preferred, including a desired amount of time to be indicated.

Once computing device 14 has determined the types of vehicles associated with a given segment of road over a determined period of time, computing device 14 may retrieve data indicating the relative safety for each type of vehicle determined. The relative safety of each type of vehicle may be stored locally to the user within device 10, a memory stored locally to computing device 14, or retrieved from a remote cloud-based source. For example, computing device 14 may retrieve a set of information 38 indicating a list of known safety features, such as accident-avoidance technologies, installed within each make, model, and year of vehicle.

In another example, computing device 14 may retrieve from a vehicle manufacturer a set of proprietary information 40 indicating the relative safety of each model of its vehicles. For example, a vehicle manufacturer may maintain records indicating a mile-per-accident ratio for each of its vehicle fleets.

Once computing device 14 has retrieved information regarding the relative safety factors for each determined type of vehicle, processing circuitry 42 may then process this data to determine and assign a single unique relative safety ranking for each type of vehicle. For example, fully autonomous vehicles and/or vehicles with low miles-per-accident ratios may be determined to have a higher relative safety ranking than non-autonomous vehicles and/or vehicles with high miles-per-accident ratios. Some entities, such as SAE International™ and the Auto Alliance™, use a sliding scale to indicate the degree of autonomy of a vehicle, with a rating of “0” indicating a fully manual vehicle and a “5” indicating a fully autonomous vehicle. In some examples, processing circuitry 42 may assign a higher relative safety ranking to vehicles rated “5” on this scale than vehicles rated “0”.

Processing circuitry 44 within computing device 14 may then process the vehicle relative safety rankings with data indicating the number of types of vehicles associated with each candidate route to determine a relative safety rating for the route. Processing circuitry 44 may also factor in safety data from other sources to determine the relative safety of a candidate route, such as current traffic data, historical accident data, and physical route features, and weight them according to user-indicated preference or a pre-determined algorithm.

Finally, processing circuitry 46 within computing device 14 may compare the individual relative safety ratings for each candidate route to determine the candidate route having the highest relative safety rating and recommend that route to the user through device 10 as the safest recommended route. Computing device 14 may output information indicative of the selected recommended route, either to a separate navigation system, or directly for display to the user, such as on a screen of device 10.

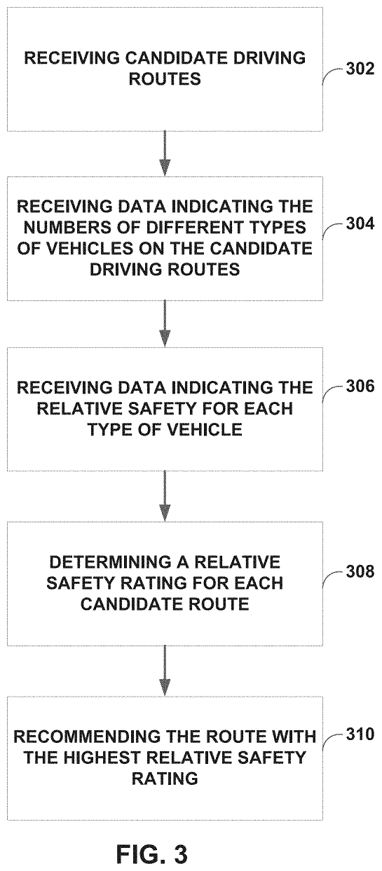

FIG. 3 is a flow diagram depicting a method of determining a route to a destination, in accordance with some examples of this disclosure. A navigation system including a user input device 10, such as a mobile device, a personal computing device, a GPS navigation device, or factory-installed vehicle navigation systems, receives user input indicating a starting location, an intended destination, and a set of criteria for a route between the two locations. A computing device 14, either located within the original user input device 10 or in a remote cloud-based data center may either determine a set of candidate routes between the starting location and the intended destination, or receive the set of candidate routes from a separate route-calculating system 24 (302).

Based on the set of candidate routes, computing device 14 may retrieve data indicative of the number and types of vehicles associated with each of the candidate routes (304). This information may indicate, for example, the number and/or relative concentration of each manufacturer, vehicle model, and year of manufacture of each vehicle recorded travelling on a given segment of a route over a pre-determined period of time. For example, computing device 14 may retrieve images from a traffic camera depicting different vehicles on the route segment in the camera's field-of-view. Processing circuitry within computing device 14 may then analyze the camera image data to recognize and tally the different types of vehicles depicted. In some examples, computing device 14 may analyze the camera images to recognize license plates, and retrieve the corresponding make and model of vehicle from a vehicle registration database, such as from a state's Department of Motor Vehicles (DMV).

Computing device 14 may further retrieve information indicative of the relative safety of each type of vehicle recognized (306). For example, this information may indicate advanced safety features, such as the accident-avoidance technologies, installed on each type of vehicle. In another example, this information may include a relative vehicle safety rating indicating the degree of autonomy of each type of vehicle, based on a presumption that vehicles having a higher degree of autonomy are less likely to be in an accident with the vehicles in their vicinity.

Computing device 14 may also retrieve other information indicative of candidate route safety, for example, traffic along that route, historical accident data from that route, or physical route features, such as sharp turns, animal crossings, etc.

Computing device 14 may process these data inputs according to a predetermined algorithm and/or weighted user preferences to determine and assign a relative safety rating for each candidate route to the destination (308). For example, a candidate driving route having a high percentage of fully autonomous vehicles may receive a high relative safety rating compared to a candidate driving route having a high percentage of non-autonomous vehicles.

Computing device 14 may compare the relative safety ratings for each of the candidate routes to determine the candidate route having the highest relative safety rating, and output information indicative of that route as the “safest” recommended route to the user's local device 10, such as for display on a mobile device (310).

The example techniques described in this disclosure may be a computing device, a method, and/or a computer program product. The computer program product may include a computer readable storage medium (or media) having computer readable program instructions thereon for causing a processor to carry out aspects of one or more examples described in this disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network (e.g., network 14), for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of one or more examples described in this disclosure.

Aspects of the disclosure are described herein with reference to flowchart illustrations and/or block diagrams of methods, apparatus (systems), and computer program products according to one or more examples. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various examples of this disclosure. In this regard, each block in the flowchart or block diagrams may represent a module, segment, or portion of instructions, which comprises one or more executable instructions for implementing the specified logical function(s). In some implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The description of the present disclosure has been presented for purposes of illustration and description and is not intended to be exhaustive or limited to the disclosure in the form disclosed. Many modifications and variations will be understood by persons of ordinary skill in the art based on the concepts disclosed herein. The particular examples described were chosen and disclosed in order to explain the techniques described in the disclosure and example practical applications, and to enable others of ordinary skill in the art to understand the disclosure for various examples with various modifications as are suited to the particular use contemplated. The various examples described herein are within the scope of the following claims.

What is claimed is:

1. A system comprising:
a receiver configured to receive, based on a first driving route, first route data indicative of amounts and relative concentrations of different types of vehicles associated with the first driving route; and
processing circuitry configured to:
determine, based at least in part on the first route data and safety data indicating safety of the different types of vehicles, a first relative safety rating for the first driving route;
determine, based at least in part on the first relative safety rating, a recommended driving route; and
output information indicating the recommended driving route.

2. The system of claim 1, wherein the safety data indicates accident-avoidance technology installed in the different types of vehicles.

3. The system of claim 1, wherein the safety data indicates degrees of autonomy for the different types of vehicles.

4. The system of claim 1, wherein the first route data comprises image data, wherein the receiver is configured to receive the image data from at least one camera, and wherein the processing circuitry is configured to execute image-recognition software that causes the processing circuitry to recognize the different types of vehicles from the image data.

5. The system of claim 1, wherein the first route data indicates the amounts and the relative concentrations of the different types of vehicles currently on the first driving route.

6. The system of claim 1, wherein the first route data indicates the amounts and the relative concentrations of the different types of vehicles on the first driving route during a recent pre-determined time interval.

7. The system of claim 1, wherein the first route data indicates the amounts and the relative concentrations of the different types of vehicles ever determined to be on the first driving route.

8. The system of claim 1, wherein the processing circuitry is configured to determine the recommended driving route by comparing the first relative safety rating for the first driving route to a second relative safety rating for a second driving route.

9. The system of claim 1, wherein the processing circuitry is further configured to determine the first relative safety rating based on one or more of:
historical accident data for the first driving route;
current traffic data for the first driving route; or
physical route features of the first driving route.

10. A method comprising:
receiving, based on a first driving route, first route data indicative of amounts and relative concentrations of different types of vehicles associated with the first driving route;
determining, based at least in part on the first route data and safety data indicating safety of the different types of vehicles, a first relative safety rating for the first driving route;
determining, based at least in part on the first relative safety rating, a recommended driving route; and
outputting information indicating the recommended driving route.

11. The method of claim 10, wherein the safety data indicates accident-avoidance technology installed in the different types of vehicles.

12. The method of claim 10, wherein the safety data indicates degrees of autonomy for the different types of vehicles.

13. The method of claim 10, wherein the first route data comprises image data, the method further comprising:
receiving the image data from at least one camera; and
recognizing the different types of vehicles from the image data.

14. The method of claim 10, wherein the first route data indicates the amounts and the relative concentrations of the different types of vehicles currently on the first driving route.

15. The method of claim 10, wherein the first route data indicates the amounts and the relative concentrations of the different types of vehicles on the first driving route during a recent pre-determined time interval.

16. The method of claim 10, wherein determining the recommended driving route comprises comparing the first relative safety rating for the first driving route to a second relative safety rating for a second driving route.

17. The method of claim 10, further comprising determining the first relative safety rating based on one or more of:
historical accident data for the first driving route;
current traffic data for the first driving route; or
physical route features of the first driving route.

18. A computer-readable storage medium storing instructions thereon that when executed cause one or more processors to:
receive, based on a first driving route, first route data indicative of amounts and relative concentrations of different types of vehicles associated with the first driving route;
determine, based at least in part on the first route data and safety data indicating safety of the different types of vehicles, a first relative safety rating for the first driving route;
determine, based at least in part on the first relative safety rating, a recommended driving route; and
output information indicating the recommended driving route.

19. The computer-readable storage medium of claim 18, wherein the safety data indicates accident-avoidance technology installed in the different types of vehicles.

20. The computer-readable storage medium of claim 18, wherein the safety data indicates degrees of autonomy for the different types of vehicles.
